(19) United States
(12) Patent Application Publication
(10) Pub. No.: US 2006/0078662 A1
(43) Pub. Date: Apr. 13, 2006

(54) Crystalline maltitol composition and method for production

(76) Inventors: Paul Staniszewski, Newark, DE (US); Mary Lou Cunningham, Wilmington, DE (US)

Correspondence Address: GAIL H. GRIFFIN;MORGAN, LEWIS & BOCKIUS, L.L.P., 1701 Market Street, Philadelphia, PA, 19103-2921, US

(21) Appl. No.: 10/963,905

(22) Filed: Oct. 13, 2004

(51) Int. Cl. A23L 1/236

(52) U.S. Cl. 426/548

(57) ABSTRACT

A non-seeded method for making crystalline maltitol is described. The method includes evaporating liquid maltitol to a moisture content of between about 4.5 percent to about 6.0 percent to produce a maltitol feed; cooling said maltitol feed with water at a temperature of between about 10 degrees to about 20 degrees Celsius; and extruding said maltitol feed without using a nozzle. The process is performed without a seeding step. A crystalline maltitol composition having at least 45% by volume maltitol crystals having a size of at least 50 microns made by the method is also described.

### BACKGROUND OF THE INVENTION

U.S. Pat. No. 5,583,215, assigned to Towa Chemical Co., teaches a method for preparing crystalline maltitol. The method includes supplying an aqueous solution of maltitol having a concentration in the range of 80-98% by weight and a maltitol content in the solid component in the range of 80-99% by weight to a first zone of an extruder. The extruder has an elongated cooling zone, which cools the solution to 50-90 degrees Celsius and an elongated kneading zone, which adds and kneads in seed crystals. Seed crystals are added in an amount of 3-80% by weight based on the extruded amount to a second zone. Cooling and kneading continue in a third zone and a final zone, to a temperature of 25-60 degrees Celsius. The maltitol magma thus formed is extruded from an extrusion nozzle. The maltitol produced is a crystalline mixture having a melting point in the range of 134-145 degrees Celsius.

### SUMMARY OF THE INVENTION

The present invention relates to a composition having at least 45% by volume maltitol crystals having a size of at least 50 microns. In one aspect, the composition has a melting point of between 144 and 148 degrees Celsius. In another aspect, the composition has a percent moisture of about 0.2 to about 0.8 by weight. In yet another aspect, the composition has an average crystal size of about 230 microns.

The present invention also relates to a composition having at least 45% by volume maltitol crystals, the crystals having a size of at between about 50 microns and 500 microns. In one aspect, the composition has a melting point of between 144 and 148 degrees Celsius. In another aspect, the composition has a percent moisture of about 0.2 to about 0.8 by weight. In another aspect, the composition has an average crystal size of about 230 microns.

The present invention also relates to a composition having at least 35% crystals by volume of 50 microns or more in size. In one aspect, the composition has a melting point of between 144 and 148 degrees Celsius. In another aspect, the composition has a percent moisture of about 0.2 to about 0.8 by weight. In another aspect, the composition has an average crystal size of about 230 microns.

The present invention also relates to a process for preparing crystalline maltitol. In one embodiment, the process includes evaporating liquid maltitol to a moisture content of between about 4.5 percent to about 6.0 percent to produce a maltitol feed;

cooling the maltitol feed with water at a temperature of between about 10 degrees to about 20 degrees Celsius; and extruding the maltitol feed without using a nozzle. In one aspect, the process is performed without a first seeding the maltitol feed with seed crystals. In one aspect, the liquid maltitol is evaporated to a moisture content of 4.5 percent. In another aspect, the process also includes the step of heating the maltitol feed to a temperature of between about 88 degrees and 96 degrees Celsius. In another aspect, the maltitol is heated to a temperature of between about 90 degrees to about 95 degrees Celsius. In another aspect, the invention includes a crystalline maltitol product produced by this process.

### BRIEF DESCRIPTION OF THE DRAWINGS

FIG. 1 is a photomicrograph of the crystalline maltitol of the present invention, produced without using a nozzle. (180× Magnification).

FIG. 2 is a photomicrograph of the crystalline maltitol of the present invention, produced without using a nozzle. (180× Magnification).

FIG. 3 is a photomicrograph of the crystalline maltitol of the present invention, produced without using a nozzle. (180× Magnification).

FIG. 4 is a photomicrograph of the crystalline maltitol of the present invention, produced without using a nozzle. (180× Magnification).

FIG. 5 is a photomicrograph of the crystalline maltitol of the present invention, produced using a nozzle. (180× Magnification).

FIG. 6 is a photomicrograph of the crystalline maltitol of the present invention, produced using a nozzle. (180× Magnification).

FIG. 7 is a photomicrograph of AMALTY® MR50 crystalline maltitol, used as a control sample. (180× Magnification).

FIG. 8 is a photomicrograph of AMALTY® MR50 crystalline maltitol, used as a control sample. (180× Magnification).

### DETAILED DESCRIPTION OF THE INVENTION

The present invention relates to methods for producing crystalline maltitol without seeding with crystals, and crystalline maltitol products produced by such a process.

In one embodiment of the present invention, the method includes evaporating liquid maltitol to a specified moisture content, feeding the evaporated maltitol to an extruder, cooling the maltitol feed to a desired temperature, and extruding the maltitol feed with or without using a nozzle.

In one aspect of the present invention, the maltitol starting material is in liquid form, and is from about 40% to about 99% solids. In another embodiment, the maltitol is from about 50% to about 80% solids. In yet another embodiment, the maltitol is about 70% solids. Commercially available liquid maltitol useful in the method of the present invention includes Maltisweet™ M95 (SPI Polyols, Inc., New Castle, Del.).

In an embodiment of the present invention, liquid maltitol is evaporated at a temperature of from about 40 degrees Celsius to about 95 degrees Celsius. In another embodiment of the present invention, the liquid maltitol is evaporated at a temperature of from about 45 degrees Celsius to about 80 degrees Celsius. In yet another embodiment, the evaporation temperature is about 60 degrees Celsius. In an embodiment of the method of the present invention, the evaporation takes place under vacuum. In another embodiment, evaporation takes place without application of a vacuum.

Typically, it is necessary to retain some moisture in the maltitol after evaporation is complete to aid in the crystallization process. In an embodiment of the method of the present invention, the liquid maltitol is evaporated to a moisture content of from about 1% to about 10%. In another embodiment, the moisture content is from about 2% to about 7%. In yet another embodiment of the present invention, the moisture content of the evaporated maltitol is from about 3% to about 6%. In another embodiment, the moisture content is from about 4.5% to about 6%. In another embodiment, the moisture content is about 4.5%.

After evaporation, in one embodiment, maltitol is fed through feed lines to an extruder. In an embodiment of the method of the present invention, the maltitol feed is heated to a temperature of from about 75 degrees Celsius to about 100 degrees Celsius. In another embodiment, the maltitol feed is heated to from about 80 degrees Celsius to about 95 degrees Celsius. In yet another embodiment, the maltitol feed is heated to from about 88 degrees Celsius to about 95 degrees Celsius. In another embodiment, the maltitol feed is heated to about 93 degrees Celsius.

In an embodiment of the invention, steam tracers and jacketing are used to control the temperature of the maltitol feed. In use, the pressure of the steam is increased to decrease the viscosity and thereby increase the temperature of the maltitol feed; the pressure of the steam is decreased to increase the viscosity and thereby decrease the temperature of the maltitol feed.

In an embodiment of the present invention, the maltitol feed rate to the extruder is from about 16 to about 32 pounds per hour. In another embodiment, the maltitol feed rate is from about 20 to 28 pounds per hour. In yet another embodiment, the feed rate is about 24 pounds per hour. A limiting factor in determining an optimal feed rate is the point at which the maltitol feed begins to stick to the belt (discussed below) due to insufficient cooling.

The maltitol feed crystallizes in the extruder. In an embodiment of the present invention, the maltitol feed is mixed in the extruder for from about 5 to about 8 minutes, depending on the feed rate. In an embodiment of the present invention, the extruder will have the characteristics of the mixing device described in U.S. Pat. No. 3,618,902. In an embodiment of the present invention, a Readco 2″ Continuous Processor extruder (Readco Manufacturing, Inc., York, Pa.) is used. The mechanics of the Readco extruder are essentially as described in U.S. Pat. No. 3,618,902, with the optional addition of a nozzle and hot oil system for the nozzle. In an embodiment of the invention, the Readco mixer has the following configurations and capabilities:
Mixer Internal Volume: 0.033 cubic feet
Mixer Weight: 800 pounds
Maximum Torque Input to Agitator Shafts: 5 horsepower at 125 revolutions per minute (rpm)=2520 lb-in.
Material of Construction
   Barrel Wetted Surfaces: 316 SST
   Agitators: 316 SST
   Agitator Shafts: 17-4. PH SST
   Remainder: Carbon Steel
Barrel Jackets
   100 psig
   450 degrees Maximum Temperature
   1 square foot jacket area
   Barrels are of a manual clamshell design.

In an embodiment of the invention, the Readco unit is equipped with three thermowall ports which can double as a liquid injection port. Three plastic melt thermocouples are supplied. Discharge is through a manual bottom slide gate. The mixing chamber to shaft seals are stuffing boxes. The Readco Continuous Processor is designed to mix viscous products on a continuous basis by utilizing a combination mixing and conveying action. The lens shaped mixing elements, combined with Figure “8” shaped barrels, produce a self-wiping action between the agitators and the barrels, and between the agitators to minimize buildup of product except for the normal operating clearances of the moving parts. The mixing chamber is jacketed for heating or cooling.

The products to be mixed (powders, granules, liquids, etc.) are continuously metered (with feeders or pumps) into the rectangular opening in the top mixer barrel. Liquids may be introduced into the injection ports located in the bottom barrel. Several variables make the Readco adaptable for a wide variety of mixing operations. These variables are pragmatically derived, but can be more closely approximated as experience with the mixer increases:
Agitator speed
Jacket temperature
Feed rate and accuracy of feed rate
Selection of proper bottom barrel liquid injection port can set up mixing zones and vary the retention time of the injected liquids

Retention time is a function of feed rate and the volume of the product that is in the mixer at a given time. Theoretical maximum retention time is equal to Mixer volume/Feed rate. Since the mixer is typically not 100% full, this maximum retention time is typically not obtained. Back pressure on the mixer controlled by the size opening of the discharge gate can increase retention time. Retention time can be more closely approximated by the insertion of colored dyes measuring their time for discharge.

The agitator assemblies consist of a mixer shaft and a series of various types of mixing elements. The mixing elements can be installed in a variety of linear or angular positions. The flat agitators are useful for high mixing intensity, and have no conveying action. The helical agitators are useful for moderate mixing intensity and have moderate conveying action. The screw sections are useful for low mixing intensity and high conveying action. The relative angular position of the agitators with its following agitator can alter mixing characteristics. Relative position of one agitator to its following agitator is determined by keyway positions. For example, a series of flat agitators, each mounted in the same keyway position will usually have increased mixing intensity over a series of flat agitators using a staggered keyway position, and a series of flats and/or helical agitators each keyed 45 degrees from its following agitator, forming a spiral (or a broken screw) can produce significant conveying action in either direction depending upon the direction of the spiral. Although the combinations are unlimited, it is recommended that a feed screw section be used on each shaft of the mixer inlet and a reverse helical agitator be used as the last element in the discharge end. It is required that all agitators be mounted on the shaft 90 degrees out of phase with its mating agitator.

Without being bound to any particular theory, it is hypothesized that the agitators in the extruder generate a great deal of sheer when mixing the maltitol. The sheer generated by the agitators initiates the crystallization process, thereby eliminating the need to use seed crystals. In one embodiment of the method of the present invention, the extruder mixes at a speed of from about 30 rpm to about 100 rpm. In another embodiment, the extruder mixing speed is from about 40 rpm to about 80 rpm. In yet another embodiment, the extruder mixing speed is from about 50-60 rpm. In another embodiment, the extruder mixing speed is about 60 rpm.

Other types of extruders may be useful in the present invention. It is within the skilled artisan's knowledge to determine, based upon the disclosure herein, the type and appropriate parameters for other types of extruders to produce a crystalline maltitol product.

Typically, the crystallization process generates heat, and it is important to control the temperature during the crystallization process. Excess or insufficient heat will prevent crystallization. In one embodiment of the present invention, the temperature of the extruder is controlled using a cooling jacket. Water in the cooling jacket cools the maltitol feed down while in the extruder, and also absorbs the heat generated from the crystallization process. In an embodiment of the present invention, the water in the cooling jacket is at a temperature of from about 5 degrees Celsius to about 35 degrees Celsius. In another embodiment, the water is at a temperature of from about 10 degrees Celsius to about 20 degrees Celsius. In yet another embodiment, the water is at a temperature of about 12 degrees Celsius.

In an embodiment of the method of the present invention, the crystallized maltitol is extruded from the extruder without using a nozzle. In another embodiment, the crystallized maltitol is extruded from the extruder using a nozzle. In one embodiment, the nozzle is heated. In an embodiment of the present invention, the temperature of the heated nozzle is between about 75 degrees Celsius and about 90 degrees Celsius.

In an embodiment of the present invention, the extrudate is dropped from the extruder onto a belt and permitted to cure in the ambient air for from about 10 seconds to about 2 minutes. In another embodiment, the extrudate cures on the belt for from about 20 seconds to about 1.5 minutes. In another embodiment, the extrudate cures on the belt for from about 30 seconds to about 60 seconds.

In another embodiment of the present invention, the extrudate is conveyed to paddle blenders to allow time to cure. In an embodiment of the present invention, heated, dehumidified air is passed through the extruder to allow the maltitol to cure enough to avoid melting as the maltitol is fed to the dryer. In an embodiment of the present invention, the temperature of the heated air is from 37 degrees Celsius to about 66 degrees Celsius (about 100 to about 150 degrees Fahrenheit). In another embodiment, the temperature of the heated air is from about 43 degrees Celsius to about 55 degrees Celsius (about 110 to about 130 degrees Fahrenheit). In an embodiment of the present invention, residence time in the paddle blenders is from about 30 minutes to about 1 hour. In another embodiment, residence time is about 45 minutes.

In an embodiment of the present invention, the extrudate moves from the blenders and passes through a crusher to break up large pieces of maltitol. From the crusher, the extrudate moves to the dryer, and continues to cure. In an embodiment of the present invention, residence time in the dryer is from about 30 minutes to about 3 hours. In another embodiment, residence time in the dryer is from about 45 minutes to about 2.5 hours. In another embodiment, residence time in the dryer is from about 60 minutes to about 2 hours.

The present invention also includes a crystalline maltitol product produced by the method of the present invention. In an embodiment of the present invention, the crystalline maltitol product has a melting point of from about 143 degrees Celsius to about 149 degrees Celsius. In another embodiment, the melting point is from about 144 degrees Celsius to about 148 degrees Celsius. In another embodiment, the melting point is about 144.72 degrees Celsius. In another embodiment, the melting point is about 147.25 degrees Celsius.

In an embodiment of the maltitol product of the present invention, the maltitol product has a moisture content of from about 0.05% to about 1%. In another embodiment, the moisture content is from about 0.1% to about 0.8%. In yet another embodiment, the moisture content is from about 0.227% to about 0.718%.

In an embodiment of the maltitol product of the present invention, the maltitol product produced without using a nozzle has a high percentage of large, single crystals, as compared to the maltitol crystals produced with a heated nozzle, and as compared to commercially available products, such as AMALTY® MR50 from Towa Chemical Co. In one embodiment of the present invention, the large crystals are greater than about 50 microns. In another embodiment, the large crystals are between about 50 microns and 800 microns.

In another embodiment, the large crystals are between about 50 microns and 500 microns. In one embodiment of the present invention, the percentage of large crystals is up to about 75%. In another embodiment of the present invention, the percentage of large crystals is up to about 65%. In another embodiment, the percentage of large crystals is up to about 55%. In another embodiment, the percentage of large crystals is up to about 45%. In another embodiment, the percentage of large crystals is up to about 35%. In another embodiment, the percentage of large crystals is up to about 25%.

In an embodiment of the composition of the present invention, the large crystals are present in the composition singularly. In another embodiment, the large crystals are fused together. In another embodiment, large crystals overlap each other.

Without being bound to any particular theory, it is believed that the crystals of maltitol produced by the method of the present invention without using a nozzle are larger because the crystals are not being forced through a nozzle. The heat from the heated nozzle used in producing Sample 2, is believed to cause melting and reformation of crystals as the maltitol is being extruded through the nozzle, thereby producing less structured, smaller crystals.

In an embodiment of the invention, the large, single crystals display birefringence, indicating that the crystal has depth, or that the lattice structure varies throughout the crystal. Variation in the lattice structure of large crystals does not necessarily indicate that the lattice structure is poor. Rather, variation in lattice structure indicates bends or curves in the crystal structure (i.e., that the crystal has shape). In an embodiment of the composition of the present invention, the large crystals have a good quality lattice structure.

In an embodiment of the present invention, small crystallites (discussed in more detail below), have a poor lattice quality (high percentage of lattice distortion). Poor lattice quality indicates a lower percent crystallinity. Therefore, a composition having a higher percentage of small crystallites will have a poor overall lattice quality, and will be less crystalline than a composition having a low percentage of small crystallites, for example, the composition of the present invention. In an embodiment of the composition of the present invention, the overall composition has a lower percentage of small crystallites and therefore a lower percent lattice distortion and a higher percent crystallinity than both a composition produced using the method of the present invention with a heated nozzle and the prior art AMALTY® M50 (Towa Chemical Co., Japan) composition. In one embodiment, the lattice distortion of the composition of the present invention is from about half to about two-thirds less than the lattice distortion of either a composition produced using the method of the present invention with a heated nozzle or the prior art AMALTY® M50 composition. Stated another way, the composition of the present invention is more crystalline than either a composition produced using the method of the present invention with a heated nozzle or the prior art AMALTY® M50 composition.

In another embodiment of the present invention, the composition of the present invention has a low percentage of amorphous material, also called “glass phase” material. The amorphous material is poorly defined structurally. In an embodiment of the present invention, the amorphous material is present in the composition at between about 10% to about 45%. In another embodiment, the amorphous material is present in the composition at between about 20% to about 40%. In another embodiment, the amorphous material is present in the composition at about 35%.

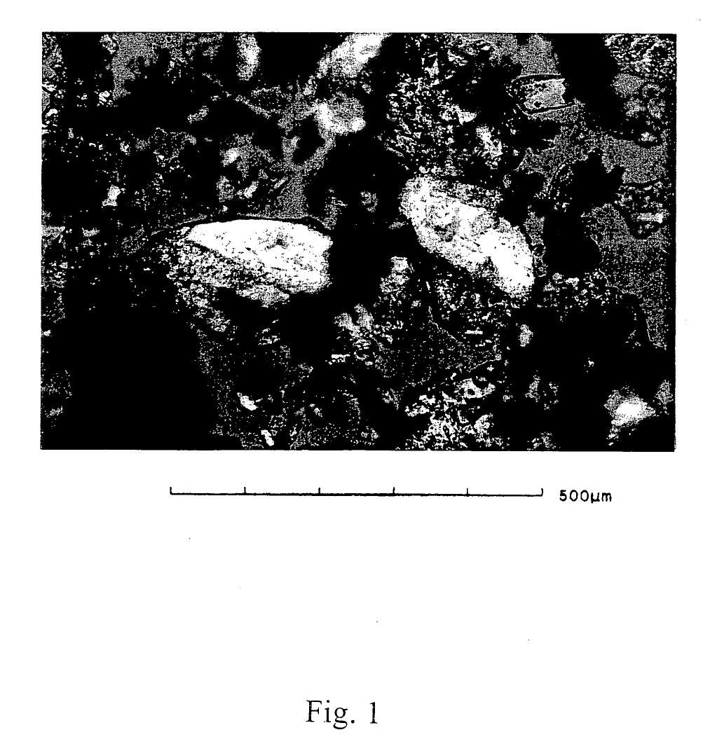

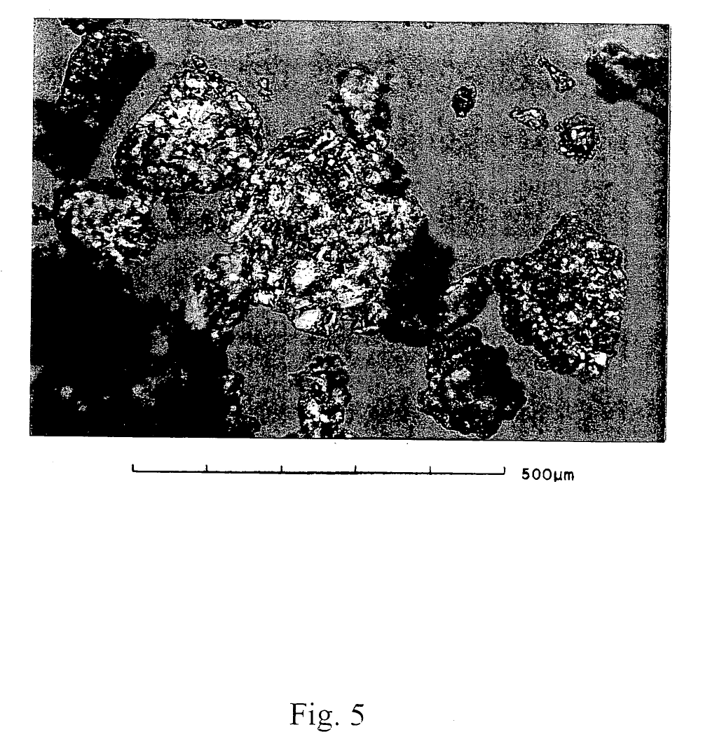

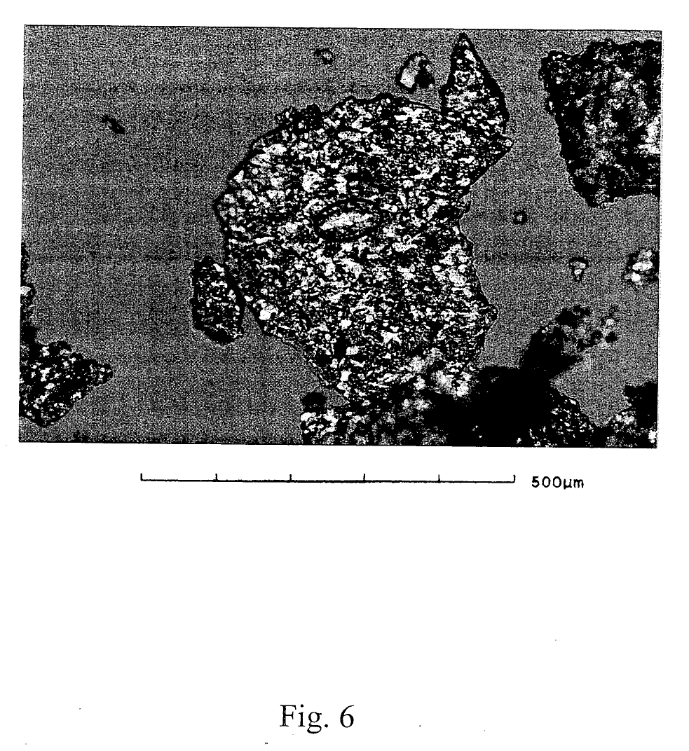

FIGS. 1-4, discussed in more detail in the Examples, depict various aspects of the maltitol crystals of the present invention. As compared with FIGS. 5 and 6, which depict maltitol crystals prepared by the same process but extruded through a heated nozzle, FIGS. 1-4 primarily depict large crystals whereas large crystals are essentially absent in FIGS. 5 and 6.

The following examples are given to illustrate the present invention. It should be understood, however, that the invention is not to be limited to the specific conditions or details described in these examples. Throughout the specification, any and all references to a publicly available document, including but not limited to a U.S. patent, are specifically incorporated by reference.

### EXAMPLE 1

### Establishment of Conditions Useful for Production of Non-Seeded Crystalline Maltitol Without Use of A Nozzle

The objective of this example was to establish preferred conditions for production of a non-seeded crystalline maltitol using a 2″ Readco Processor as the extruder.

Materials and Methods

The Readco Processor used in all experiments is essentially as described in U.S. Pat. No. 3,618,902.

The general method for conducting this example was as follows: Liquid maltitol was evaporated and fed into a 2″ Readco Processor with a jacket cooler. The maltitol was processed in the Readco and extruded onto a conveyor belt to cure.

Results

Moisture Content. It was determined that the preferred water content for the maltitol feed is between about 4.5 percent to about 6 percent. It is preferable that the moisture content be between about 4.5 percent and about 5.5 percent. If the moisture content is too high, the resulting crystalline maltitol is wet and unmanageable. If the moisture content is too low, the maltitol will not properly crystallize. Alternatively, the maltitol could start to nucleate when subjected to energy, causing the material to set in the feed tank or the feed lines.

Feed Tank Temperature. It was determined that the preferred feed tank temperature ranges from about 88 to about 96 degrees Celsius. It is preferable that the feed tank temperature ranges from about 90 to about 95 degrees Celsius. At temperatures below 88 degrees Celsius, it was found that the maltitol material set in the feed tank. Temperatures above 96 degrees Celsius were too difficult to balance against the cooling step, and resulted in a wet, unmanageable rope of maltitol.

Speed of Readco. It was determined that the preferred speed of the Readco Processor is about 60 rpm. The steam tracers on the feed lines were set at 20 psig while running. The purpose of the steam tracers and jacketing is to control the temperature of the maltitol being fed to the Readco. The maltitol must be hot enough to avoid setting in the feed lines, but it must cool enough for the Readco to remove the heat during the crystallization process. The steam pressure is increased or decreased in order to decrease or increase the viscosity of the maltitol feed.

Cooling to Readco Jacket. It was determined that the preferred water temperature to the jacket of the Readco ranges from about 10 to about 20 degrees Celsius. Too low of a jacket temperature appears to inhibit curing. Too high of a jacket temperature will not adequately cool the material in the Readco and appears to inhibit crystallization.

### EXAMPLE 2

### Production of Non-Seeded Crystalline Maltitol Without Nozzle

The objective of this example was to determine whether a non-seeded crystalline maltitol could be produced using a 2″ Readco without the nozzle. The Readco Processor is essentially as described in U.S. Pat. No. 3,618,902.

Materials and Methods

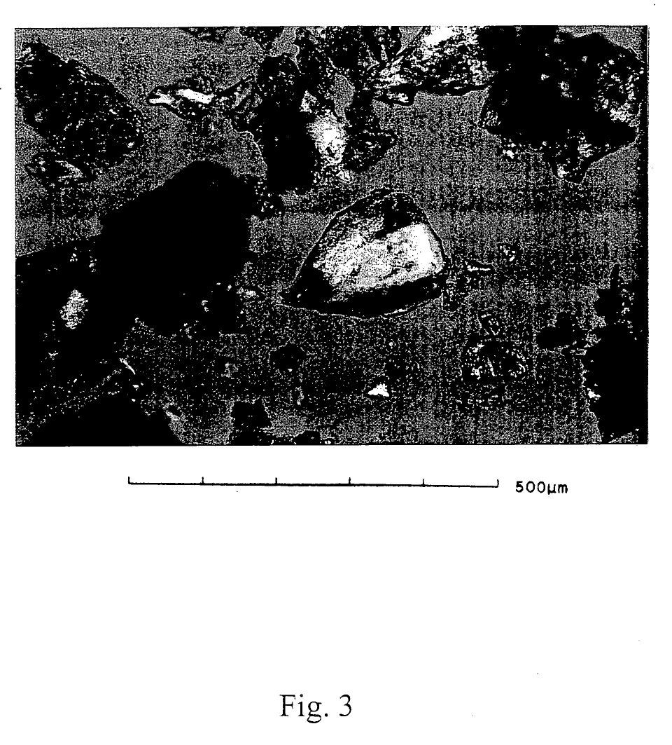

The nozzle and nozzle plate normally used on the 2″ Readco were removed. This left a 3″×2″ opening directly below the paddles at the discharge end of the Readco (See FIG. 3).

Liquid maltitol was evaporated at 60 degrees Celsius under vacuum to a moisture content of 4.5%. The maltitol was then heated to 95 degrees Celsius and fed to the Readco Processor. The feed rate for the maltitol without the nozzle was about 21 pounds per hour, as compared to the feed rate with the nozzle, which was about 31 pounds per hour. The maltitol crystallized in the Readco, which was set at 60 rpm for about 30 minutes. The water in the Readco jacket was 45 degrees Celsius. The crystallized maltitol was extruded onto a Sandvik conveyor belt (Sandvik Process Systems, Totowa, N.J.) and allowed to cure there for about 30 seconds. The maltitol product was then analyzed by baking in an oven at 105 degrees Celsius.

Results

Within 30 minutes, a well-nucleated extrudate was being produced. A well-nucleated extrudate can be recognized by the change in color and consistency of the maltitol feed. Initially, the maltitol feed is clear. As it starts to crystallize, the maltitol feed becomes creamy white and gritty, until it is solid enough to put on the belt without sticking to it. The extruded material (“extrudate”) was globular in shape.

The extrudate did not stick to the cutter or stick together as compared to the extrudate produced using a nozzle. Although the irregular globules were much larger in diameter than the extrudate produced using a nozzle, the globules appeared to cure to a rigid state quicker than the extrudate produced using a nozzle.

Samples of the extrudate produced were placed in a lab oven at 70 degrees Celsius and held over the weekend. Samples out of the oven were extremely hard. A sample of the heated extrudate was roughly ground, and the moisture content was assessed to be between 0.718% to 1.063%.

Additional heated extrudate was ground, and screened through a 30-mesh screen. The screened extrudate was placed in a 105 degrees Celsius oven, and sampled at 1.5, 3.5, and 5.5 hours.

Table 1 illustrates the percent moisture, melting point (in degrees Celsius), and energy needed to melt the sample (in joules per gram) at various time points at 105 degrees Celsius.

TABLE 1

| Hours at 105 | Percent | Melt Point | Melt Energy |
|---|---|---|---|
| degrees Celsius | Moisture | (degrees Celsius) | (Joules per gram) |
| 0 | 0.718 | 144.72 | 128.7 |
| 1.5 | 0.451 | 145.63 | 133.0 |
| 3.5 | 0.266 | 147.16 | 127.9 |
| 5.5 | 0.227 | 147.25 | 135.2 |

Therefore, it is demonstrated herein that a crystallized maltitol product can be produced using a non-seeding method and without using the nozzle of the Readco.

### EXAMPLE 3

### Crystallographic Analysis of Crystalline Maltitol

Three types of crystalline maltitol were sent for crystallographic analysis to Genck International (Richton Park, Ill.). Sample 1 (Lot R-8-194) was crystalline maltitol produced by the non-seeded, no nozzle method of the present invention. Sample 2 (Lot R-8-6) was crystalline maltitol produced by the same non-seeded process, with a nozzle. Sample 3 (Lot 801505) was AMALTY® MR 50 (Towa Chemical Co., Tokyo, Japan) crystalline maltitol.

Sample 1 was the most crystalline of each of the samples. Sixty-five percent (65%) by volume of the sample was in crystal form, broken down into three crystal phases: (1) large single crystals (50-480 microns); (2) small crystallites (5-25 microns), usually present in multicrystalline groups; and (3) amorphous or “glass” phase. The small crystallites were dispersed in the amorphous phase, and the crystallite structure was less perfect than the single crystals.

About sixty percent (60%) by volume of Sample 2 was in crystal form. Overall, the lattice structure of the crystals in this sample was less defined than the structure of the crystals in Sample 1. Large crystals are essentially absent. Crystals up to about 110 microns long are present, but these crystals are long and narrow, and the lattice structure is relatively poor, with very little faceting. The distribution of the small crystallites in the amorphous phase is uniform, compared with Samples 1 and 3.

Lattice distortion was measured by polarized light and Schelierien microscopy. Lattice distortion refers to the small crystallites only in this Example. As shown in Table 2, below, the percent lattice distortion for each of the three samples is similar. However, since the percent lattice distortion refers only to the small crystallites and the percent of small crystallites in Sample 2 is three times that of Sample 1, the lattice structure quality is three times poorer in Sample 2 than in Sample 1. The poor lattice structure indicates a lower percent crystallinity. Therefore, the difference in percent crystallinity of Sample 2 as compared with Sample 1 is relatively significant (i.e., Sample 2 is less crystalline than Sample 1 due to poorer lattice structure.) About forty percent (40%) of Sample 3 was in crystal form. No large single crystals were found, and only about 5 to 10 percent of the small crystallites were similar to the small crystallites of Samples 1 and 2. About 80 percent of the remaining small crystallites were in individual grains of the sample. Lattice quality of the small crystallites was poor, and many portions of the particles were fused subunits with different orientations, distorted lattices, and poorly defined boundaries.

The size range and average sizes of the small crystallites in each of the Samples were similar (see Table 3). The average size of the small crystallites in 90% of the sample analyzed in Sample 1 was slightly less (14 microns) than that of Samples 2 (19 microns) and 3 (22 microns), which were similar. The overall size range distribution for the small crystallite phase of each of the Samples was also similar. A notable difference between Sample 1 and the other Samples 2 and 3 is the high percentage of large crystal content, with an average crystal size of about 230 microns. These large crystals are essentially absent in Samples 2 and 3.

The following Table 2 summarizes crystal distribution in each of the samples:

TABLE 2

| | % large | | | |
|---|---|---|---|---|
| | crystals | % multicrystalline or | | |
| | (>50 | “small crystallites” | % lattice | % amorphous |
| Sample | microns) | (5-25 microns) | distortion | or “glass” |
| 1 | 45 | 20 | 12-15 | 35 |
| 2 | — | 60 | 8-10 | 40 |
| 3 | — | 40 | 15-18 | 60 |

The following Table 3 summarizes crystal size in microns:

TABLE 3

| | Crystallites in Multicrystalline Phase | | | | |
|---|---|---|---|---|---|
| | | Size Range | | Large Single | |
| | Overall Size | Including 90% | | Crystal Phase | |
| Sample | Range | of Grains* | Average | Range | Average |
| 1 | 3-70 | 5-25 | 14 | 50-480 | 230 |
| 2 | 3-110 | 6-27 | 19 | — | — |
| 3 | 2-90 | 4-33 | 22 | — | — |

*Only about 10% of the crystallites are greater or less than this size range.

FIGS. 1-4 are micrographs of Sample 1 at 180× magnification. The darkened areas in each of the figures are entrapped bubbles. The amorphous material appears to match the background color and the small crystallites appear mottled with several different colors (in the Figures, the small crystallites appear as various shades of gray).

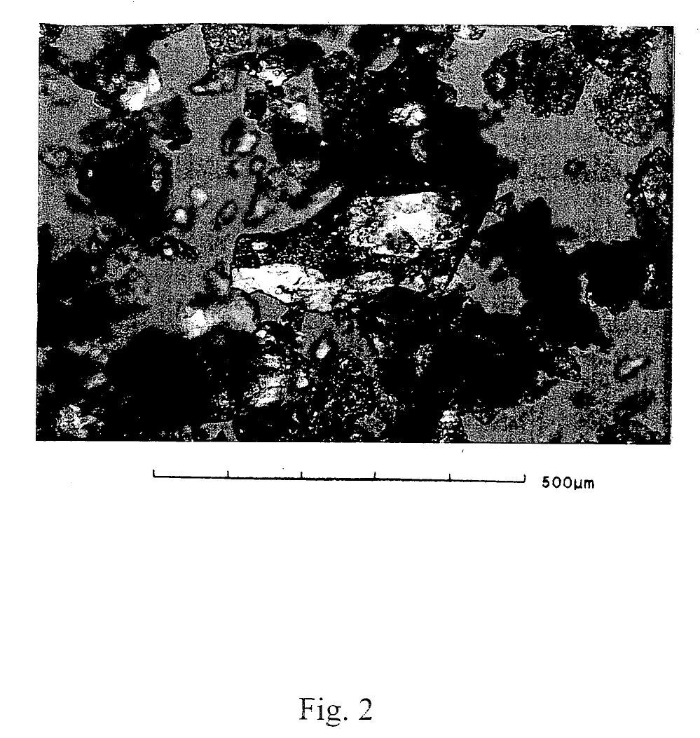

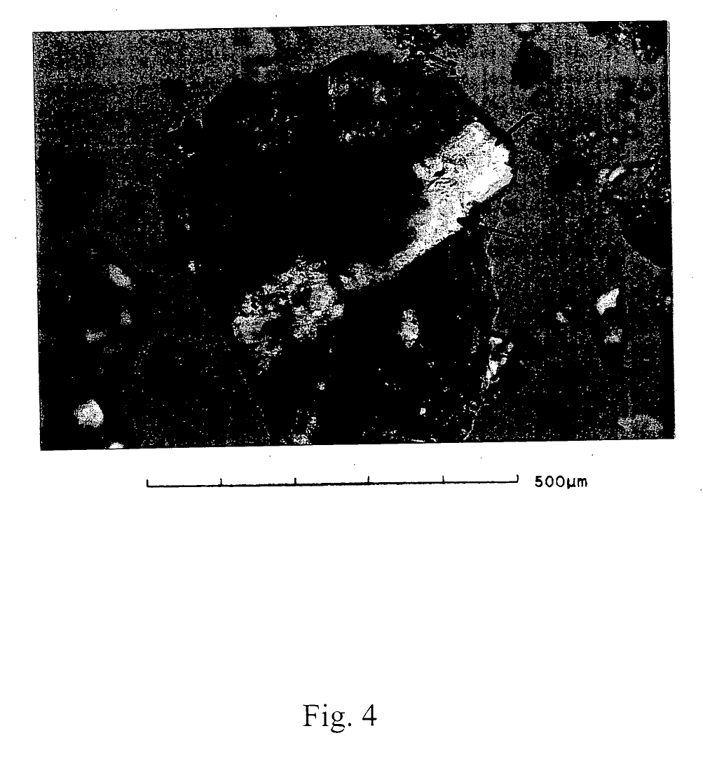

FIG. 1 is an example of two large crystals, indicated by arrows. The crystals are partially faceted and embedded in a matrix of mixed amorphous and multicrystalline structure. FIG. 2 is an example of a rectangular particle, indicated by the arrow, with birefringent color banding and faceting. This crystal is also embedded in a combined amorphous and multicrystalline structure. FIG. 3 is another example of a particle that is separated from the matrix. This particle has a good faceted phenoytpe, but a variable lattice structure, indicated by the birefringence. FIG. 4 is a sample of two large, elongated, birefringent faceted single crystals (indicated by arrows) embedded in a vesiculated amorphous material. The crystals overlap each other in the center of the micrograph. Some smaller single crystals are partially hidden in the matrix (circled). Generally, the larger particles in Sample 1 are crystallite/amorphous matrix or large, single crystals and the small particles are predominantly amorphous.

FIGS. 5 and 6 are micrographs of Sample 2 at 180× magnification. The darkened areas in each of the figures are entrapped bubbles. The amorphous material appears to match the background color and the small crystallites appear mottled with several different colors (in the Figures, the small crystallites appear as various shades of gray).

FIG. 5 depicts crystallite/amorphous matrix material. Large single crystals are absent in this Figure. The amorphous material blends in with the background color, while the multicrystalline phase is indicated by lighter shading. A small, single crystal (about 100 microns; circled) can be found at the center of the small crystallite/amorphous matrix in FIG. 6; however, it is evident from these figures and other data collected but not shown here that (1) large crystals are essentially absent; (2) large particles are essentially absent; and (3) any large particles appearing in Sample 2 have essentially the same crystallite/amorphous microstructure as small particles.

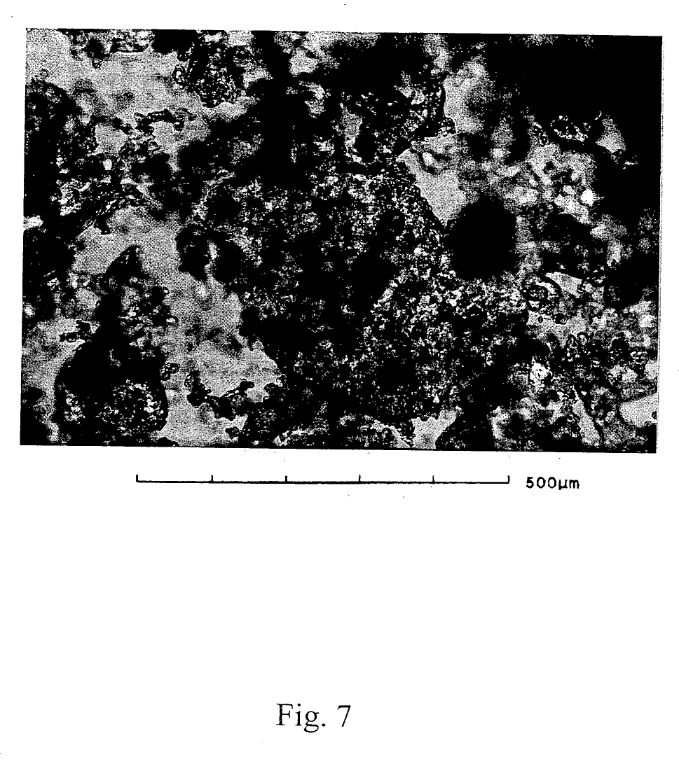

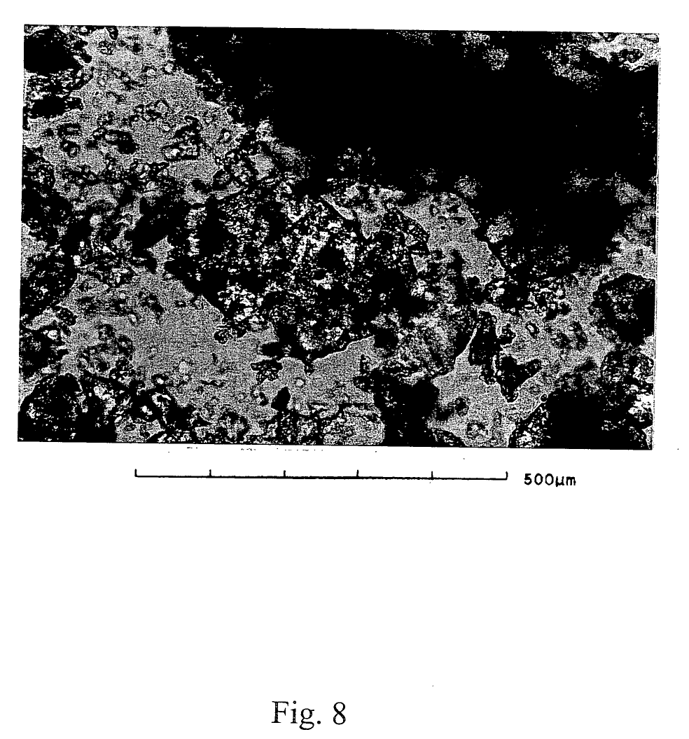

FIGS. 7 and 8 are color micrographs of Sample 3 at 180× magnification. The darkened areas in each of the figures are entrapped bubbles. The amorphous material appears to match the background color and the small crystallites appear mottled with several different colors (in the Figures, the small crystallites appear as various shades of gray).

Overall, FIGS. 7 and 8 demonstrate that Sample 3 is much less crystalline than either Sample 1 or Sample 2. The particles tend to be have more vesiculation (air bubbles) than either Sample 1 or 2 as indicated by the darkened areas in FIGS. 7 and 8. In addition, smaller particles tend to be amorphous, and larger particles vary extensively in content, ranging from crystallite/amorphous matrix to just amorphous matrix. There is considerable variation from particle to particle, with some particles having very little multicrystalline phase, while others have a dense multicrystalline phase. FIG. 7 is an example of a dense multicrystalline phase, and FIG. 8 is an example of a moderate amount of multicrystalline phase. Single crystals larger than 25 microns are extremely rare in Sample 3. Particles containing crystallite structures are small and have poor lattice structure.

The disclosures of every patent, patent application, and publication cited herein are incorporated herein by reference in their entirety.

While the invention has been disclosed with reference to specific embodiments, it is apparent that other embodiments and variations of this invention can be devised by others skilled in the art without departing from the true spirit and scope of the invention. The appended claims include all such embodiments and equivalent variations.

1. A composition comprising at least 45% by volume maltitol crystals having a size of at least 50 microns.

2. The composition of claim 1, characterized by a melting point of between 144 and 148 degrees Celsius.

3. The composition of claim 1, characterized by a percent moisture of about 0.2 to about 0.8 by weight.

4. The composition of claim 1, characterized by an average crystal size of about 230 microns.

5. A composition comprising at least 45% by volume maltitol crystals having a size of at between about 50 microns and 500 microns.

6. The composition of claim 5, characterized by a melting point of between 144 and 148 degrees Celsius.

7. The composition of claim 5, characterized by a percent moisture of about 0.2 to about 0.8 by weight.

8. The composition of claim 5, characterized by an average crystal size of about 230 microns.

9. A composition comprising at least 35% by volume crystals having a size of at least 50 microns.

10. The composition of claim 9, characterized by a melting point of between 144 and 148 degrees Celsius.

11. The composition of claim 9, further characterized by a percent moisture of about 0.2 to about 0.8 by weight.

12. The composition of claim 9, further characterized by an average crystal size of about 230 microns.

13. A process for preparing crystalline maltitol comprising:
a) evaporating liquid maltitol to a moisture content of between about 4.5 percent to about 6.0 percent to produce a maltitol feed;
b) cooling said maltitol feed with water at a temperature of between about 10 degrees to about 20 degrees Celsius; and
c) extruding said maltitol feed without using a nozzle; wherein said process is performed without a seeding step.

14. The process of claim 13, wherein said moisture content is 4.5 percent.

15. The process of claim 13, further comprising the step of heating the maltitol feed to a temperature of between about 88 degrees and 96 degrees Celsius.

16. The process of claim 15, wherein the temperature is between about 90 degrees to about 95 degrees Celsius.

17. A crystalline maltitol product prepared by the method of claim 13.
